(19) United States
(12) Patent Application Publication
(10) Pub. No.: US 2008/0282567 A1
(43) Pub. Date: Nov. 20, 2008

(54) TAPE MEASURE HAVING MARKING APERTURES

(76) Inventors: Robert Lewis Ribby, Eaton Rapids, MI (US); Jeff Griggs, (US)

Correspondence Address: Mr. Jeffrey Griggs, 122 South River Street, Eaton Rapids, MI, 48827, US

(21) Appl. No.: 11/780,810

(22) Filed: Jul. 20, 2007

Related U.S. Application Data
(60) Provisional application No. 60/807,890, filed on Jul. 20, 2006.

(51) Int. Cl. G01B 3/10

(52) U.S. Cl. 33/755

(57) ABSTRACT

The present application relates generally to tape measures and more specifically is directed to an improved tape measure that defines one or more apertures for allowing a user to precisely mark a measured item.

### CROSS REFERENCE TO RELATED APPLICATIONS

This application claims the benefit of U.S. Provisional Application No. 60/807,890, filed Jul. 20, 2006, which is incorporated by reference herein in its entirety.

### BRIEF SUMMARY OF THE INVENTION

The present application relates generally to tape measures and more specifically is directed to an improved tape measure that defines one or more apertures for allowing a user to precisely mark a measured item.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a side view of a tape measure structured in accordance with one embodiment of the present invention;

FIG. 2 is a top view of a tape measure structured in accordance with one embodiment of the present invention;

FIG. 3A is a top view of a measuring tape portion of a tape measure structured in accordance with one embodiment of the present invention;

FIG. 3B is a top view of a measuring tape portion of a tape measure structured in accordance with one embodiment of the present invention; and

FIG. 3C is a top view of a measuring tape portion of a tape measure structured in accordance with one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

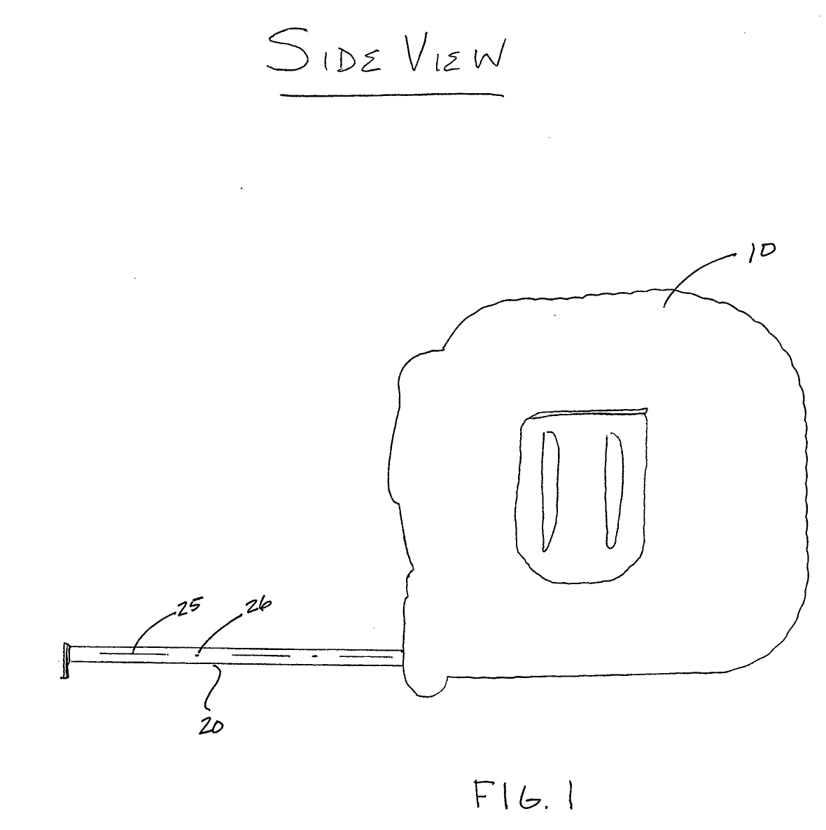

FIG. 1 depicts a tape measure 10 having a measuring tape portion 20 structured in accordance with one embodiment of the present invention. The depicted measuring tape portion 20 defines a plurality of first apertures 25 and second apertures 26 that are sized to receive a user's pen, pencil, or other marking implement. In this way a user is better able to precisely mark a measured item (not shown).

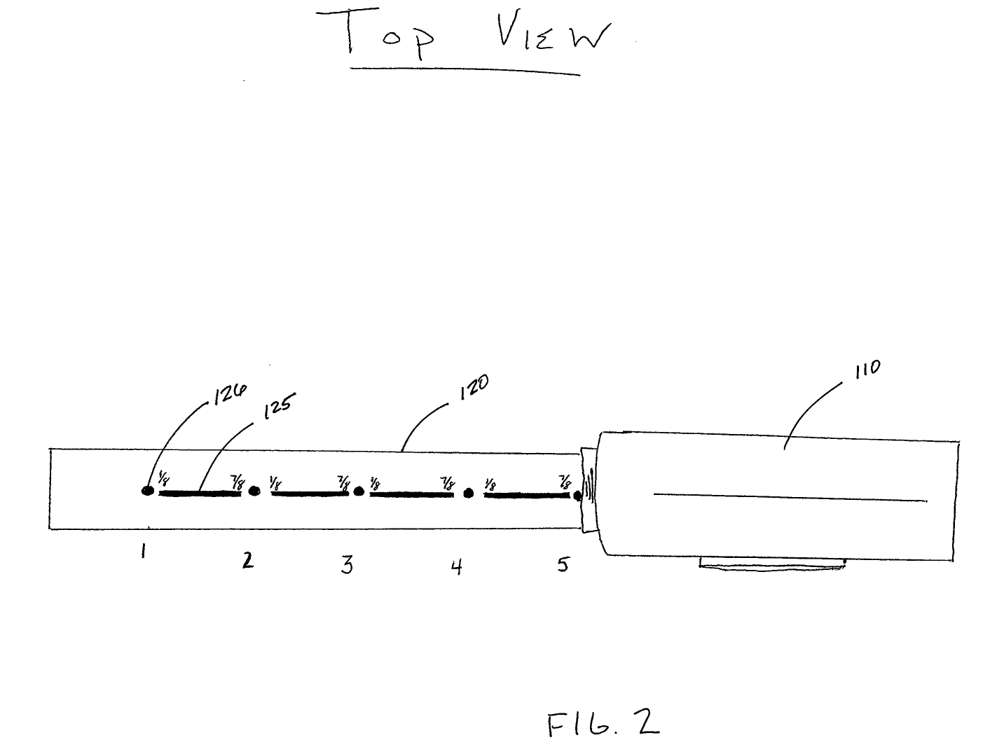

FIG. 2 depicts a tape measure 110 having a measuring tape portion 120 structured in accordance with one embodiment of the present invention. The depicted measuring tape portion 120 defines a plurality of first apertures 125 and second apertures 126 that are sized to receive a user's pen, pencil, or other marking implement. In one embodiment, the second apertures 126 may be defined at one inch intervals along the length of the measuring tape portion 120 and the first apertures 125 may be defined between adjacent second apertures 126 as shown. In this way a user is better able to precisely mark a measured item (not shown).

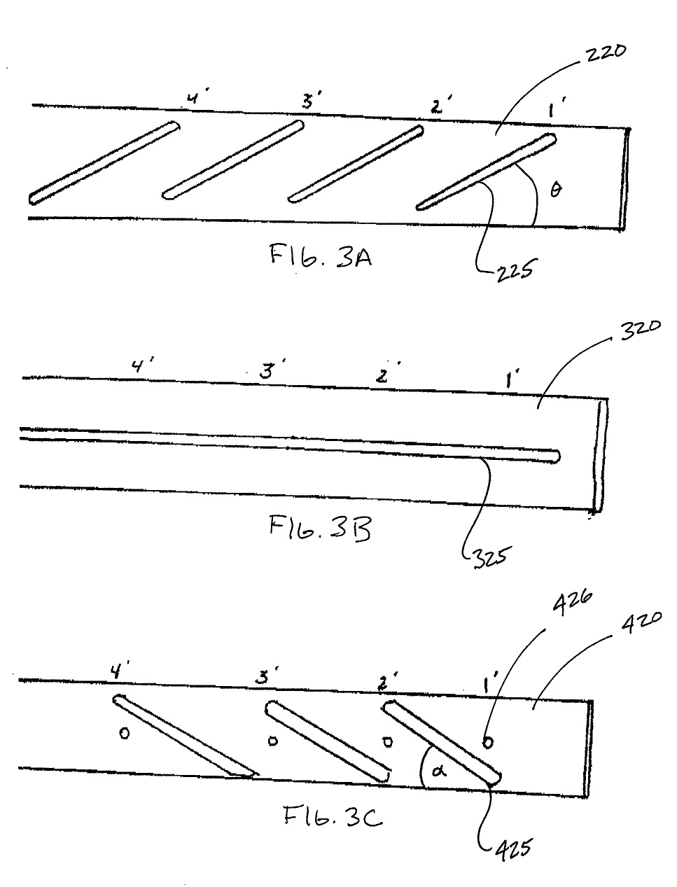

FIG. 3A depicts a measuring tape portion 220 of a tape measure structured in accordance with another embodiment of the present invention. The depicted measuring tape portion 220 defines a plurality of apertures 225 that are sized to receive a user's pen, pencil, or other marking implement. In one embodiment, the apertures 225 may be defined at an angle θ and sized to extend across one inch intervals as shown. In other embodiments, the plurality of apertures 225 may overlap one another such that a user may place a mark within at least one of the apertures 225 over the full length of the measuring tape portion 220 as will be apparent to one of ordinary skill in the art. The specific angle θ at which the apertures 225 are defined in FIG. 3A is provided for illustration purposes only. A variety of additional angles θ may be used without deviating from the inventive concepts herein described.

FIG. 3B depicts a measuring tape portion 320 of a tape measure structured in accordance with another embodiment of the present invention. The depicted measuring tape portion 320 defines an aperture 325 that is sized to receive a user's pen, pencil, or other marking implement. In one embodiment, the aperture 325 may be centrally located and sized to extend across the significant portion of the length of the measuring tape portion 320 as shown. In other embodiments, the aperture 325 need not be centrally located on the measuring tape portion 320 and instead may be offset toward either the top or bottom of the measuring tape portion 320 as will be apparent to one of ordinary skill in the art.

FIG. 3C depicts a measuring tape portion 420 of a tape measure structured in accordance with another embodiment of the present invention. The depicted measuring tape portion 420 defines a plurality of first apertures 425 and second apertures 426 that are sized to receive a user's pen, pencil, or other marking implement. In one embodiment, the first apertures 425 may be defined at an angle α and sized to extend across one inch intervals as shown. The second apertures 426 may be centrally located at one inch intervals to allow for central marking at such common measurement locations. In other embodiments, the plurality of first apertures 425 may not overlap one another and, thus, the second apertures 426 may be needed to allow a user to place a mark within at least one of the first or second apertures 425, 426 along the full length of the measuring tape portion 420. The specific angle α at which the first apertures 425 are defined in FIG. 3C is provided for illustration purposes only. A variety of additional angles α may be used without deviating from the inventive concepts herein described.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What claimed is:

1. An enhanced measuring aperture for the general tape measure. The tape is comprised of:
a) Apertures manufactured in the form of a circle placed at the one inch, two inch, three inch, etc measured lengths
b) Apertures manufactured in the form of a line placed in a straight line format across the length of the tape horizontally
c) Apertures manufactured in the form of a line placed in a straight line format across the length of the tape diagonally
d) An aperture manufactured in the form of a straight line directly through the center of the tape.
